(19) United States
(12) Patent Application Publication
(10) Pub. No.: US 2013/0008047 A1
(43) Pub. Date: Jan. 10, 2013

(54) APPARATUS AND METHOD OF AERATING A FRONT-LOADED WASHER

(76) Inventor: Shirley S. Hunt, Moreland, GA (US)

(21) Appl. No.: 13/176,600

(22) Filed: Jul. 5, 2011

(51) Int. Cl. F26B 19/00

(52) U.S. Cl. 34/218

(57) ABSTRACT

An apparatus for aerating a washer having a front door, comprising a neck portion having a first end and a second end, a head portion carried by said first end of said neck, a foot portion having means for removably attaching the apparatus to the washer, wherein said foot portion is carried by said second end of said neck, and wherein said apparatus is positioned between the washer and the door thus keeping the door ajar when the washer is not in use and thereby allowing proper aeration.

### TECHNICAL FIELD

The technical field generally relates to washing machines and more specifically to an apparatus and method for aerating a front-loaded washer.

### BACKGROUND

Front-loaded washers have become increasingly more popular. The door of a front-loaded washer is typically designed such that it is mechanically urged to a closed position. After wet clothing is removed, unless manual force is applied by the user the door is urged to said closed position.

The problem with this design, however, is that the damp/wet environment within the washer and around the door seal remains present as the interior portions are not allowed to aerate and thus dry. Ultimately, these conditions can lead to mold and/or mildew and even toxic black mold. These are obviously undesired conditions that can lead to a multitude of both-short term and long-term health problems. As a frequently utilized and necessary appliance in most homes, these health issues could have wide-spread consequences. Consequently, there is an unmet need for an apparatus and method for aerating a front-loaded washer thereby reducing the risks of mold/mildew-infested washers.

### SUMMARY

The present invention meets and satisfies the above-unmet need by providing a unique and novel apparatus and method for removably aerating a front-loaded washer.

Generally speaking, the preferred embodiment of the present invention comprises a head portion, a neck portion and a foot portion. The head portion comprises a sponge having a rigid member inserted therein, wherein the neck portion extends therefrom said rigid member. At the distal end of the neck portion is said foot portion which comprises, in the preferred embodiment, a suction cup for removably attaching the present invention to the washer such that when the door is urged closed, it will contact the head portion and thus remain open. A holder is provided wherein said holder can be attached to the side of the washer and wherein the present apparatus can be hung thereon when not in use.

### BRIEF DESCRIPTION OF THE DRAWINGS

The following detailed description of preferred and alternate embodiments is better understood when read in conjunction with the appended drawings. For the purposes of illustration, there is shown in the drawings exemplary embodiments; however, the subject matter is not limited to the specific elements and instrumentalities disclosed. In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

FIG. 1 is a top view of the preferred embodiment of the apparatus of the present invention;

FIG. 2 is a top view of the preferred embodiment of the holder of the present invention;

FIG. 3 is a view of the preferred embodiment of the present invention as shown in use on a washer; and

FIG. 4 is a view of the preferred embodiment of the present invention as shown in its holder and not in active use.

### DETAILED DESCRIPTION OF ILLUSTRATIVE EMBODIMENTS

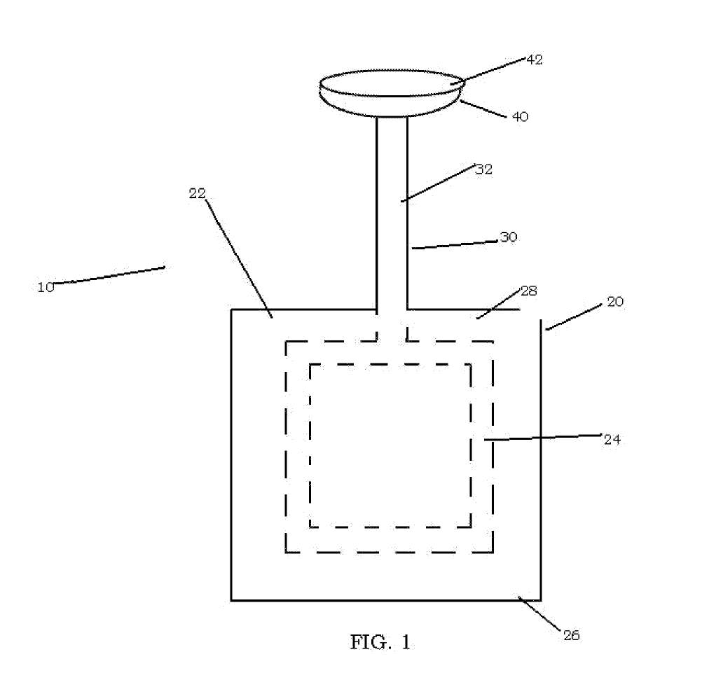

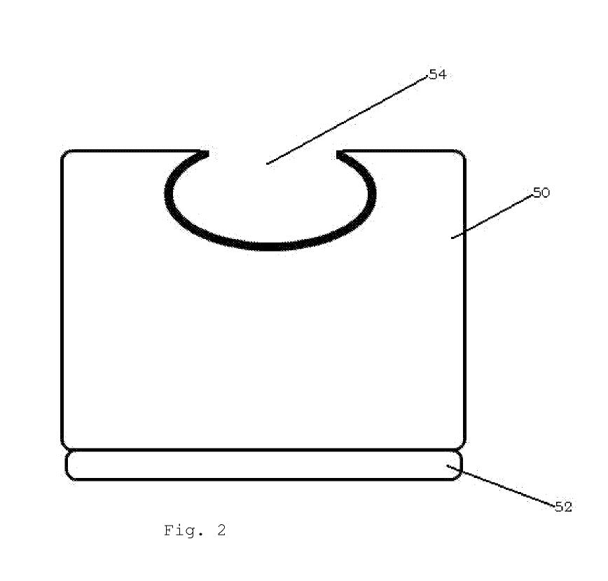

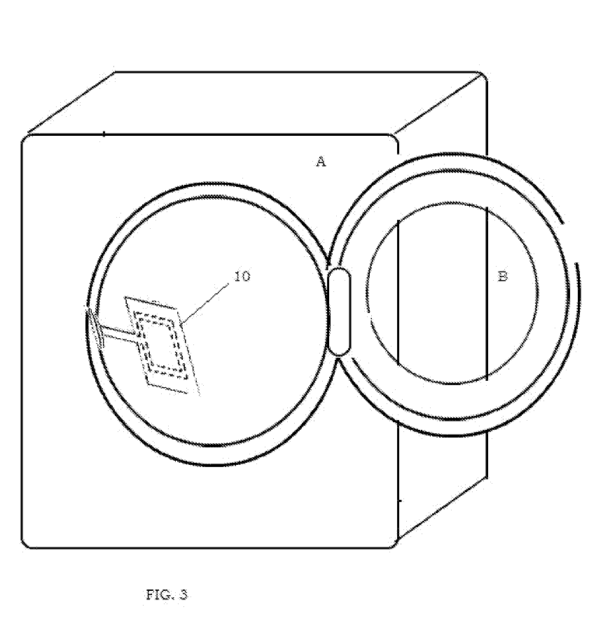

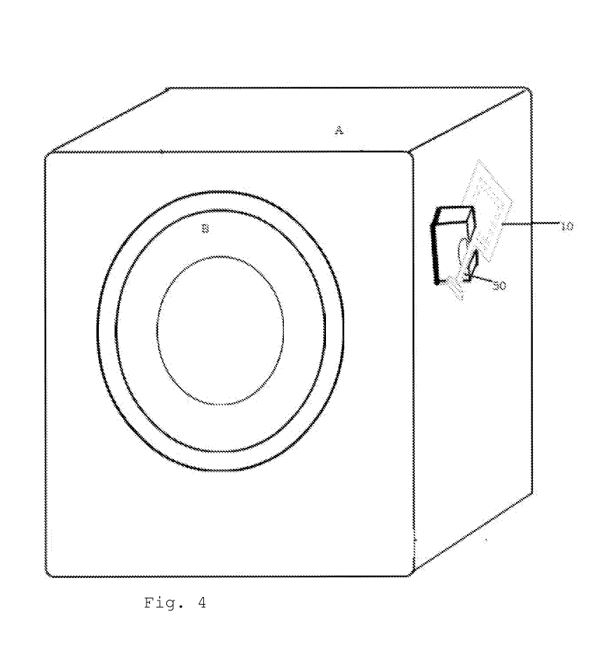

FIG. 1 illustrates one embodiment of the present invention; FIGS. 2 illustrates the holder and FIG. 3-4 illustrate one embodiment in use on a washer.

Now referring to FIG. 1, device 10 preferably comprises a head portion 20, a neck portion 30, and a foot portion 40. Head portion 20 generally comprises sponge 22 and rigid member 24 wherein sponge 22 has a leading edge 26 and a rearward edge 28. A slit is formed through rearward edge 28 for receiving rigid member 24 within sponge 22, wherein neck portion 30 extends therefrom rigid member 24. At the distal end of the neck portion 30 is foot portion 40 which comprises, in the preferred embodiment, suction cup 42 for removably attaching device 10 to washer A. Although a suction cup is preferred, a magnet or other known attaching means can be utilized. It should also be noted that in alternate embodiments, rigid member 24 can be formed within sponge 22 during manufacturing. In an additional alternative embodiment, device 10 could just be an enforced sponge portion that is positioned between the door and the washer.

Now referring to FIGS. 3-4, when door B is opened, device 10 is attached to washer A at the receiving door B rim area preferably approximately half way down, wherein head portion 20 extends outward therefrom toward door B. When door B is urged closed, it will contact and be stopped by head portion 20 and thus remain open. The sponge portion of device 10 can also be utilized to soak up any residual water in the gasket near drain.

Holder 50 is provided wherein holder 50 can be attached to the side of washer A and wherein device 10 can be hung thereon when not in use. A cut out portion 54 is generally U-shaped and dimensioned to receive device 10 therein. On the backside of holder 50 is a strip of adhesive 52 for attaching to washer A. Although the preferred embodiment is as described above, in alternate embodiments, the cut-out portion can be formed of other shapes or can be a clip or other known attaching means. The strip of adhesive 52 is preferred; however, other attaching means such as magnets can be utilized.

The foregoing description and drawings comprise illustrative preferred and alternate embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not necessarily constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

What is claimed:

1. An apparatus for aerating a washer having a front door, comprising:
a neck portion having a first end and a second end;
a head portion carried by said first end of said neck;
a foot portion having means for removably attaching the apparatus to the washer, wherein said foot portion is carried by said second end of said neck, and wherein said apparatus is positioned between the washer and the door thus keeping the door ajar when the washer is not in use.

2. The apparatus of claim 1, wherein said head comprises a sponge and a rigid member carried within said sponge.

3. The apparatus of claim 1, wherein said means for removably attaching the apparatus to the washer is a suction cup.

4. The apparatus of claim 2, wherein said sponge has a slit formed on one side thereof for receiving said rigid member.

5. The apparatus of claim 1, further comprising a holder dimensioned to receive said apparatus when not in use.

6. The apparatus of claim 5, further comprising means for attaching said holder to the washer.

7. The apparatus of claim 6, wherein said means for attaching is an adhesive strip.

8. The apparatus of claim 6, wherein said means for attaching is a magnet.

9. The apparatus of claim 1, wherein said means for removably attaching the apparatus to the washer is a magnet.
